(19) United States
(12) Patent Application Publication
(10) Pub. No.: US 2010/0026696 A1
(43) Pub. Date: Feb. 4, 2010

(54) IMAGE DATA PROCESSING METHOD, IMAGE DATA PROCESSOR, AND DATA STRUCTURE

(75) Inventors: Kazuhiro Hiwada, Kanagawa (JP); Takashi Takemoto, Kanagawa (JP)

Correspondence Address: SPRINKLE IP LAW GROUP, 1301 W. 25TH STREET, SUITE 408, AUSTIN, TX, 78705, US

(73) Assignee: Kabushiki Kaisha Toshiba, Tokyo (JP)

(21) Appl. No.: 12/511,870

(22) Filed: Jul. 29, 2009

(30) Foreign Application Priority Data
Jul. 31, 2008 (JP) 2008-198709

(51) Int. Cl. G09G 5/36

(52) U.S. Cl. 345/557

(57) ABSTRACT

When writing image data which is stored in a cache memory and includes data of a plurality of virtual sub-pixels for each of a plurality of pixels, into a main memory, an image data processing method applies predetermined compression processing to the image data. When reading out the image data stored in the main memory from the main memory and writing the read image data into the cache memory, the image data processing method applies predetermined decompression processing to the read image data.

### CROSS-REFERENCE TO RELATED APPLICATIONS

This application is based upon and claims the benefit of priority from the prior Japanese Patent Application No. 2008-198709 filed in Japan on Jul. 31, 2008; the entire contents of which are incorporated herein by reference.

### BACKGROUND OF THE INVENTION

1. Field of the Invention

The present invention relates to an image data processing method, an image data processor, and a data structure, and particularly to an image data processing method, an image data processor, and a data structure configured to improve transfer efficiency of image data between a cache memory and a main memory.

2. Description of the Related Art

Conventionally, image data for displaying various images has been used widely in personal computers (hereinafter referred to as PCs), game machines, and the like. Image data includes various data such as color data for each of a plurality of pixels constituting an image. Image data is a large amount of data which is processed in a processing circuit such as a CPU, a GPU (Graphics Processing Unit), or a dedicated engine.

In recent years, image data has been improved in various ways to enhance image quality. For example, there is a technique which represents one pixel by a plurality of virtual sub-pixels in order to diminish appearance of an indentation called jaggy on an edge of an object. This technique has been disclosed, for example, in Alan Watt, “3D Computer Graphics Third Edition” 14. Anti-aliasing theory and practice, 14.7 Super sampling or Post-filtering, ADDISON WESLEY, ISBN 0-201-39855-9. For example, anti-aliasing processing is performed by representing one pixel by four sub-pixels, so that an object can be represented with a smooth edge.

However, when such a technique is used, a problem occurs in that an amount of data becomes greater because one pixel is represented by a plurality of sub-pixels. Since high-speed processing is required for processing of mass data in image data processing, there is a problem that an increase of image data amount causes reduction in transfer efficiency of image data on a data bus.

### BRIEF SUMMARY OF THE INVENTION

According to one aspect of the present invention, an image data processing method can be provided including: when writing image data which is stored in a cache memory and includes data of a plurality of virtual sub-pixels for each of a plurality of pixels, into a main memory, applying predetermined compression processing to the image data; and when reading out the image data stored in the main memory from the main memory and writing the read image data into the cache memory, applying predetermined decompression processing to the read image data.

### BRIEF DESCRIPTION OF THE DRAWINGS

FIG. 1 is a configuration diagram showing an image data processor according to an embodiment of the present invention;

FIG. 2 is a diagram for illustrating a relation between a pixel and sub-pixels according to the embodiment of the present invention;

FIG. 3 is a diagram showing an example of a data structure of each pixel during image data processing according to the embodiment of the present invention;

FIG. 4 is a diagram showing an example of a data structure of image data stored in a main memory according to the embodiment of the present invention;

FIG. 5 is a diagram for illustrating a data structure of each pixel when the pixels are stored in a cache memory according to the embodiment of the present invention; and

FIG. 6 is a diagram for illustrating a storage state of one-line data stored in the main memory according to the embodiment of the present invention.

### DETAILED DESCRIPTION OF THE INVENTION

Hereinafter, an embodiment of the present invention will be described with reference to the drawings.

### (General Configuration)

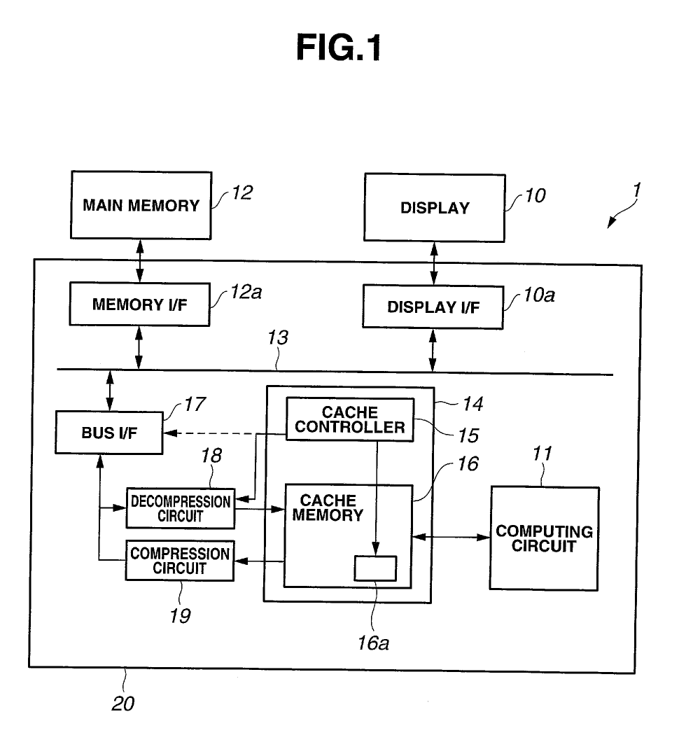

First, a configuration of an image data processor according to a present embodiment will be described based on FIG. 1. FIG. 1 is a configuration diagram showing the image data processor according to the present embodiment.

FIG. 1 shows a circuit configuration of a part of an information processor such as a PC or a game machine configured to process image data. Based on an instruction from a not shown CPU, a computing circuit 11 of an image data processor 1 reads out image data from a main memory 12 via a bus 13, performs image processing computation such as rendering processing by multisample anti-aliasing, and writes image data as a result of the computation into the main memory 12.

A cache memory unit 14 is provided between the computing circuit 11 and the main memory 12. The main memory 12 is a DDR SRAM or the like. The cache memory unit 14 includes a cache controller 15 and a cache memory 16. The cache memory 16 stores a plurality of line data. The cache memory 16 further includes a flag data unit 16a configured to store flag data f about later-described predetermined color data with respect to each sub-pixel.

A display 10 and a bus 13 are connected via a display interface (I/F) 10a. The display interface (I/F) 10a is a circuit configured to perform inter-conversion between a signal on the bus 13 and an input/output signal of the display 10, and as a main function, outputs image data to the display 10 to display the image data on the display 10. For this purpose, the display interface (I/F) 10a performs processing of reading out image data stored in the main memory 12 or the like via the bus 13, converting the image data in accordance with a specification of an input/output signal of the display 10, outputting the converted image data, and the like.

For example, in a case of displaying an image on the display 10, the following processing is repeated: 1) image data is read from the main memory 12 into the cache memory unit 14; 2) the computing circuit 11 performs a predetermined computation on the image data in the cache memory unit 14 and update; and 3) the data is written back from the cache memory 14 into the main memory 12. Then, 4) after rendering corresponding to one frame is completed, the image data is transferred from the main memory 12 to the display interface (I/F) 10a, and the image is displayed on the display 10.

In other words, when images are displayed on the display 10, the repeating processing from 1) to 3) and the processing 4) are repeated so that images are continuously displayed.

The main memory 12 and the bus 13 are connected via a memory interface (I/F) 12a. The memory interface (I/F) 12a is a circuit configured to perform inter-conversion between a signal on the bus 13 and an input/output signal of the main memory 12, and creates a control signal for access to the main memory 12 and transfers data therebetween in response to an instructions such as read or write from the bus 13.

A bus interface (I/F) 17 is connected to the bus 13. A decompression circuit 18 and a compression circuit 19 are provided between the bus I/F 17 and the cache memory unit 14. In FIG. 1, circuits other than the main memory 12 and the display 10 are included in, for example, a GPU 20.

The computing circuit 11 of the GPU 20 includes a pipeline circuit configured to perform image processing, and performs predetermined image processing, for example, rendering processing based on an instruction from the CPU.

Then, as described later, when reading out image data from the main memory 12, the cache memory unit 14 decompresses compressed image data using the decompression circuit 18 configured to perform predetermined decompression processing. When writing image data into the main memory 12, the image data processing circuitry 1 compresses the image data using the compression circuit 19 configured to perform predetermined compression processing.

Generally, the computing circuit 11 performs computation processing on image data read out from the main memory 12, and image data as a result of the computation is written into the main memory 12. Further, according to an instruction from the CPU, the image data processing circuitry 1 may operate each circuit in a so-called write only mode which allows only writing of image data to which predetermined image processing has been applied. The mode for write only is hereinafter referred to as a write only cache mode.

During the write only cache mode, the CPU gives an instruction for notifying the cache controller 15 of this mode. In response to the instruction, the cache controller 15 instructs the decompression circuit 18 to perform readout of image data corresponding to the write only cache mode as described later. In response to the instruction from the cache controller 15, the decompression circuit 18 reads out and acquires the image data from the main memory 12 in a manner as described later. During the write only cache mode, the cache controller 15 performs management of flag data of the flag data unit 16a as described later.

Alternatively, the bus I/F 17 may be configured to perform readout processing of image data corresponding to the write only cache mode as described later. In this case, the cache controller 15 instructs the bus I/F 17 to perform transfer of the image data corresponding to the write only cache mode.

During the write only cache mode, writing of a predetermined value into the flag data unit 16a, as flag data f for one-line data read out from the main memory 12, is also performed by the cache controller 15.

If the computing circuit 11 writes later-described first color data with respect to one pixel during the write only cache mode, the cache controller 15 rewrites flag data f for predetermined color data (first color data in a following example) of a corresponding sub-pixel in the flag data unit 16a such that the flag data f has predetermined data.

Although processing of flag data f of the flag data unit 16a is performed by the cache controller 15 in the present embodiment, the processing of flag data f may be performed by a different circuit.

### (Data Structure)

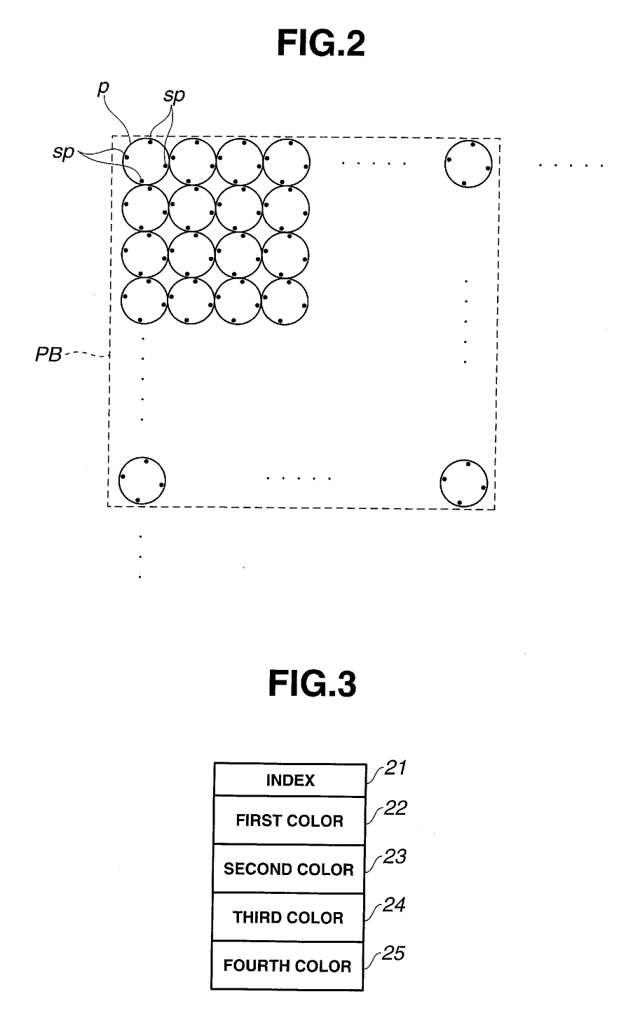

FIG. 2 is a diagram for illustrating a relation between a pixel and sub-pixels. FIG. 2 shows some of a plurality of pixels p constituting an image. As shown in FIG. 2, each of the plurality of pixels p includes four vertical sub-pixels sp1 to sp4. In other words, image data includes data of a plurality of virtual sub-pixels with respect to each of the plurality of pixels stored in the cache memory 16. In this example, image data composed of 64 (8×8) pixels is assumed to be one line data as a unit data, and a plurality of lines of image data are stored in the cache memory 16. Thus, image data of an 8×8 pixel block PB is stored in one line of the cache memory 16, and between the cache memory 16 and the main memory 12, readout and writing of image data are performed in units of such lines.

For example, these sub-pixels are sampled and used for anti-aliasing processing.

In the present embodiment, as described later, if sampling points in a same pixel are of one color, that is, colors of sub-pixels sp are all same, image data is stored in the main memory 12 in such a state that the image data is compressed to one-fourth image data excluding three pieces of color data. If the sampling points in the same pixel have two colors, the image data is stored in the main memory 12 in such a state that the image data is compressed to one-half image data excluding two pieces of color data. If the sampling points in the same pixel have three colors, the image data is stored in the main memory 12 in such a state that the image data is compressed to three-fourths image data excluding one piece of color data. If the sampling points in the same pixel have four colors, the image data is stored in the main memory 12 in an uncompressed state including all types of color data. Image data in which image data in compressed states as described above are mixed is stored in the main memory 12.

Displaying an image requires four pieces of color data for each pixel in a frame buffer. However, four pieces of color data in one pixel are often data of a same color. Therefore, during image data processing, color data of each pixel is held such that the color data is separated into four pieces of color data and index data of color data which indicates which color data is used by each sub-pixel.

FIG. 3 is a diagram showing an example of a data structure of each pixel during image data processing. For each pixel p to include color data of four sub-pixels sp, each pixel data has an index data unit 21 configured to store index data which indicates which color data is used by each sub-pixel sp. Each pixel data also has four color data units 22 to 25 which include color data of the respective pixel data. Accordingly, during image data processing, data of each pixel is separated into index data and sequence data. The sequence data is data in which color data, which is a data content of each sub-pixel associated by index data, is arranged in an order of the four color data units 22 to 25. The index data is data which indicates a rank of color data used by each sub-pixel in the order of the four color data units 22 to 25.

While an example of four color data is used here and therefore first to fourth color data can be held for each pixel, the number of color data is equal to the number of colors which can be specified in each pixel. Accordingly, if three pieces of color data can be specified, first to third data units are included, and index data is data capable of specifying three pieces of color data.

Further, while color data is stored in each of four sub-pixels sp1 to sp4, there may be a sub-pixel sp having no color data. Each pixel p has color data of at least one color. Color data here is assumed to be data of four colors, for example, color data of RGBA. First color data is first color data in the first color data unit 22. Second, third, and fourth color data are second, third, and fourth color data in the second, third, and fourth color data units 23, 24, and 25, respectively.

As described above, the index data unit 21 stores index data which indicates which color data is used by each sub-pixel sp.

For example, when the first sub-pixel sp1 uses color data of the first color data unit 22, “00” indicating the first color data unit 22 is stored as index data of the first sub-pixel sp1. When the second sub-pixel sp2 uses color data of the second color data unit 23, “01” indicating the second color data unit 23 is stored as index data of the second sub-pixel sp2. Similarly, when the third sub-pixel sp3 uses color data of the third color data unit 24, “10” indicating the third color data unit 24 is stored as index data of the third sub-pixel sp3. Similarly, when the fourth sub-pixel sp4 uses color data of the fourth color data unit 25, “11” indicating the fourth color data unit 25 is stored as index data of the fourth sub-pixel sp4.

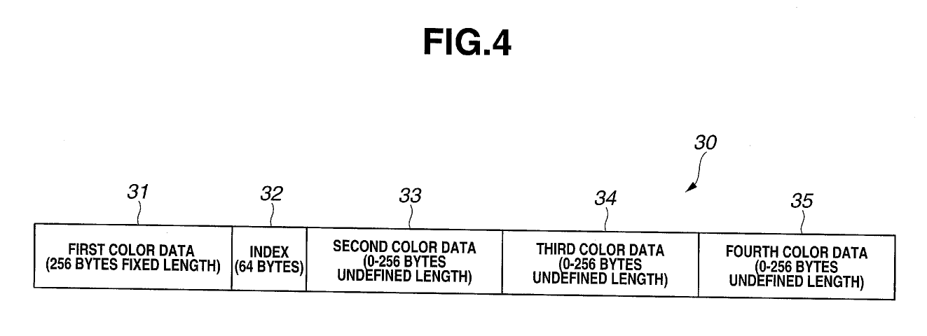

As described above, during the image data processing, each pixel data is separated into, that is, expanded to become index data and color data of each sub-pixel to be held. When image data of this structure is stored in the main memory 12, the image data is compressed by the compression circuit 19 so that the image data has a data structure as shown in FIG. 4.

FIG. 4 is a diagram showing an example of the data structure of image data stored in the main memory 12. FIG. 4 shows compressed data corresponding to one line of the cache memory 16.

In FIG. 4, compressed one-line data 30 includes first color data unit 31, index data unit 32, second color data unit 33, third color data unit 34, and fourth color data unit 35.

Data of the first color data unit 31 is data in which only first color data of 64 pixels' data in the pixel block PB are arranged in a predetermined order (for example, an order from first to 64th in the pixel block PB). Data of the index data unit 32 is data in which only index data of the 64 pixels' data in the pixel block PB are arranged in the predetermined order. Data of the second color data unit 33, the third color data unit 34, and the fourth color data unit 35 are data in which only second, third, and fourth color data of the 64 pixels' data in the pixel block PB are arranged in the predetermined order, respectively.

In other words, the first color data unit 31 is a group of per-rank data in which only color data of a plurality of pixels in a first rank (the first color data unit 22) in the order of the four color data units 22 to 25 in FIG. 3 are arranged in a predetermined order (for example, an order from first to 64th in the pixel block PB). Similarly, the second color data unit 33, the third color data unit 34, and the fourth color data unit 35 are groups of per-rank data in which only color data of the plurality of pixels in second, third, and fourth ranks (the second, third, and fourth color data units 23, 24, and 25) in the order of the four color data units 22 to 25 in FIG. 3 are arranged in the predetermined order (for example, the order from first to 64th in the pixel block PB), respectively.

The index data unit 32 is a group of index data in which index data of each of a plurality of pixels is arranged in a predetermined order (for example, the order from first to 64th in the pixel block PB).

Conversion as described above is performed by the compression circuit 19. In other words, the compression circuit 19 performs compression processing for converting each data of a plurality of pixels to a group of per-rank data and a group of index data.

As described above, among data of a plurality of pixels, there is data in a compressed state which does not use more than one piece of color data. Therefore, in some pixels, there may be none of second to fourth color data. In this case, a part having no color data is omitted so that other parts are shifted and closed up toward a head. Accordingly, a data length of the second to fourth color data units 34 to 36 becomes shorter than a data length of the first color data unit 32.

Thus, the first color data unit 32 and the index data unit 33 are fixed length data respectively, and the second to fourth color data units 34 to 36 are undefined length data respectively.

For example, when each color data has a data length of 4 bytes and each index data has a data length of 1 byte, the first color data unit 32 is fixed length data of 256 bytes and the index data unit 33 is fixed length data of 64 bytes. Each of the second to fourth color data units 34 to 36 is undefined length data of 0 to 256 bytes.

When a mishit occurs in the cache, the cache memory 14 performs cache refilling processing on a basis of per the aforementioned one line data unit, and image data is stored in the main memory 12 in a format compressed as described above. In the main memory 12, compressed image data are stored sequentially in predetermined fixed storage areas, instead of being stored in closed-up areas.

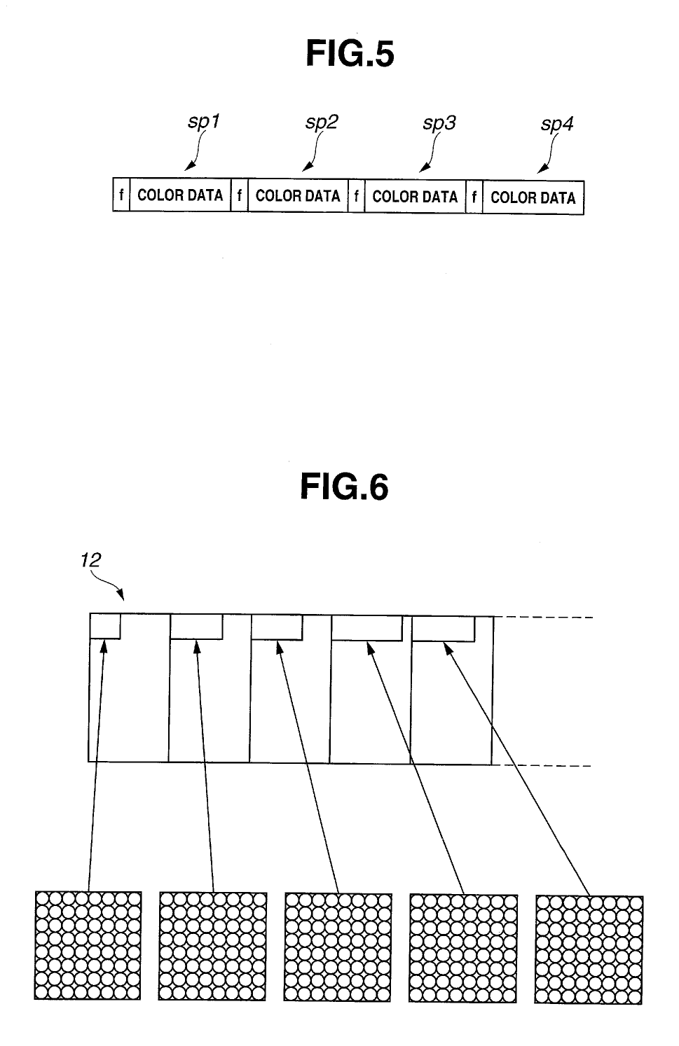

Further, raw image data is stored in the cache memory 16. FIG. 5 is a diagram for illustrating a data structure of each pixel when the pixels are stored in the cache memory 16. As described above, during data processing, each pixel data has a data structure as shown in FIG. 3, i.e., has index data and color data of four sub-pixels sp1 to sp4. However, when stored in the cache memory 16, the pixel data further includes flag data f which indicates whether or not each sub-pixel is first color data as shown in FIG. 5.

Flag data f which indicates which sub-pixel is first color data among each of sub-pixels is stored in the cache memory 16 as data for each sub-pixel. An area shown in FIG. 5 which stores a plurality of flag data f of a plurality of sub-pixels is the flag data unit 16a.

Specifically, flag data f which indicates, with respect to each pixel data, which sub-pixel is first color data and whether or not the first color data has been rewritten, is stored in the flag data unit 16a. For example, with respect to one or more sub-pixels, flag data f indicating first color data is stored.

FIG. 6 is a diagram for illustrating a storage state of one-line data stored in the main memory 12. When a plurality of compressed one-line image data 30 shown in FIG. 4 are stored in the main memory 12, the plurality of image data 30 are not arranged and stored in closed-up areas in the main memory 12, but are stored in predetermined fixed storage areas respectively in a predetermined order as shown in FIG. 6.

On the other hand, image data read out from the main memory 12 is decompressed by the decompression circuit 18 and stored in the cache memory 16 in an uncompressed state as shown in FIG. 5.

The flag data unit 16a of the cache memory 16 is a storage unit configured to store flag data f which indicates whether or not first color data is unknown with respect to each sub-pixel of each pixel.

### (Operation)

First, operation of the image data processing circuitry 1 will be described in a case where both readout and writing of line data of the cache memory 16 are performed.

When the computing circuit 11 tries to read out image data stored in the cache memory 16, if there is not the image data in the cache memory 16, then refilling operation of the cache is performed. During cache refilling, the image data processing circuitry 1 reads out the one-line data 30 shown in FIG. 4 of image data from the main memory 12, decompresses the one-line data 30 by the decompression circuit 18, and stores the decompressed data in the cache memory 16. Image data to be read out from the main memory during cache refilling is all data of the one-line data shown in FIG. 4: the first color data unit 31, the index data unit 32, the second color data unit 33, the third color data unit 34, and the fourth color data unit 35.

In writing back from the cache, the image data processing circuitry 1 compresses one line of uncompressed image data stored in the cache memory 16 as shown in FIG. 5 by the compression circuit 19, and transfers the compressed data as shown in FIG. 4 to the main memory 12. Image data to be transferred to the main memory 12 during the writing back from the cache is all data of the one-line data shown in FIG. 4: the first color data unit 31, the index data unit 32, the second color data unit 33, the third color data unit 34, and the fourth color data unit 35.

In a case where image processing by the computing circuit 11 reads out original image data, applies predetermined processing to the read image data, and writes out the given resultant image data, both readout and writing of line data as described above are performed, and therefore the operation as described above is performed.

However, in the image processing by the computing circuit 11, there is also processing which only writes predetermined color data without need to read out original image data. In a case of this processing, the image data processing circuitry 1 operates in the write only cache mode. Operation of the image data processing circuitry 1 is performed under control of the cache controller 15 according to an instruction from a not shown CPU or the computing circuit 11.

Operation during the write only cache mode will be described below.

In the write only cache mode, during cache refilling, the image data processing circuitry 1 reads out image data of the index data unit 32, the second color data unit 33, the third color data unit 34, and the fourth color data unit 35 shown in FIG. 4, instead of the whole one-line data 30 shown in FIG. 4, from the main memory 12. In other words, data of the first color data unit 31, which is a group of per-rank data for a first rank, is not read out.

The decompression circuit 18 decompresses the read image data so that the image data has the data structure shown in FIG. 5, and stores the decompressed image data in the cache memory 16. However, at this time, data of the first color data unit 32 has not been read out. Therefore, flag data f of a sub-pixel of first color data corresponding to each pixel is made to be data indicating that a value is unknown (for example, “0”), and is stored in the flag data unit 16a.

Namely, the flag data unit 16a is a storage unit configured to store an update state of the first color data of each pixel. If there are a plurality of sub-pixels which use first color data in one pixel, flag data of the plurality of sub-pixels becomes “0”.

Therefore, with respect to each sub-pixel which use first color data in all the pixels, flag data “0” indicating that color data is unknown is stored as a predetermined value in the flag data unit 16a. As for a sub-pixel whose flag data f is “0” in the pixel data in FIG. 5, a value indicating that a value of first color data is unknown is stored

When image processing is applied to the image date written into the cache memory 16 so that first color data of a certain pixel is written, “1” is written as a predetermined value which indicates the first color data is written and updated, into flag data f of a corresponding sub-pixel by the cache controller 15. In other words, when the computing circuit 11 writes the first color data of the certain pixel by subsequent processing, the cache controller 15 rewrites the flag data f of the corresponding sub-pixel in the flag data unit 16a so that the flag data f has “1” indicating that the color data is not unknown. Thus, the flag data unit 16a is a storage unit configured to store data which indicates whether first color data of each pixel remains unknown or has been written and updated by the computing circuit 11.

During writing back from the cache, the compression circuit 19 checks data of the flag data unit 16a. If flag data in the flag data unit 16a with respect to a line to be written back are all “0”, only second to fourth color data and index data are compressed and transferred to the main memory 12 because first color data has not be rewritten. In a case where a write mask is used in the compression circuit 19, first color data may also be transferred.

On the other hand, when the compression circuit 19 checks the data of the flag data unit 16a during the writing back from the cache, if at least one of the flag data in the first color flag data unit 16a with respect to a line to be written back is “1”, first to fourth color data and index data are compressed and transferred to the main memory 12 because there is the rewritten color data. Also in this case, first color data may be transferred using a write mask.

### (Advantages)

In the above described configuration, for example, since a probability that data from and after second color data unit 33 is used is usually low, if it is supposed that a data size of the first color data unit 31 is 100 when there is color data for each four sub-pixel, a size of compressed one-line data is only approximately 150 in many cases.

A size of conventional uncompressed data is 400 for four sub-pixels. Therefore, the image data processor according to the above described embodiment can improve data transfer efficiency during reading out of image data from the main memory 12.

Similarly, also in the write only cache mode, for example, if it is supposed that a data size of the first color data unit 31 is 100 and then a size of compressed one-line data is only approximately 150, a size of data to be read out for refilling is 50. Further, a data size of a transfer amount during writing back to the main memory 12 is 150. Accordingly, a data size of both of readout and writing is 200 in the write only cache mode, while a data size of both of readout and writing in a conventional case in which data compression is not performed is 800. Thus, the image data processor according to the above described embodiment has higher data transfer efficiency compared to the conventional case.

Even if a write mask is used in the conventional case without compression, a size of data is 400, and therefore the image data processor according to the above described embodiment has higher data transfer efficiency compared to the conventional case.

As described above, the above described present embodiment can improve transfer efficiency of image data between a cache memory 16 and a main memory.

In writing color data of each pixel, in order to reduce data amount, the computing circuit 11 or the cache controller 15 may settle color data of each pixel by performing processing of updating color data as follows.

As first update processing, for example, when first, third, and fourth color data have been used but second color data has not been used in color data of a certain pixel as shown in FIG. 3, the first, third, and fourth color data are changed to first, second, and third color data, and contents of the index data 21 and four color data 22 to 25 are thereby updated. In other words, because the second color data is not used, color data in FIG. 3 is closed up and data of each pixel is updated so that the first to third color data 22 to 24 are used and the fourth color data 25 is not used.

Then, when new color data is written, fourth index data and the fourth color data 25 are used.

Further, as second update processing, for example, when first, third, and fourth color data 22, 24, 25 have been used similarly, and color data of a sub-pixel to be newly written is identical to one of the already written first, third, and fourth color data 22, 24, 25, the first, third, and fourth color data 22, 24, 25 are changed to first, second, and third color data 22, 23, 24, and data of each pixel is updated so that a content of the index data 21 is updated while fourth color data is not used.

As a result, when color data to be newly written is identical to the already written color data, the fourth color data is not used.

Further, as third update processing, for example, when color data to be newly written is identical to third color data similarly, color data other than the third data, i.e., first, second, and fourth color data are closed up as in the above described second update processing, and writing of new color data as well as change of index data are then performed.

As a result, for example, it is assumed that color data other than the third color data identical to the new color data, i.e., the first, second, and fourth color data are closed up before the new color data is written, and for example, the second color data are not being used and the color data are changed to only the first and second color data. Subsequently, the new color data is added and the index data is changed. In this case, since the new color data is identical to the original third color data, the first and fourth color data are changed to first and second color data respectively, the new color data is added as third color data, and the index data is also changed.

Processing for managing data sequence by the above described various update processing may be additionally performed in processing for updating pixel data.

Although uncompressed image data is stored in the cache memory 16 in the above described embodiment, image data compressed as described above may be stored in the cache memory 16. In this case, the compression circuit 19 is not required, and as an alternative, a compression circuit is provided between the cache memory 16 and the computing circuit 11.

Although image data in the above description is data including only color data, the processing device according to the above described embodiment can also be applied to data other than color data.

According to the above described image data processor, transfer efficiency of image data can be improved.

The present invention is not limited to the above described embodiment, and various changes and modifications can be made without departing from a scope of the present invention.

What is claimed is:

1. An image data processing method comprising:
when writing image data which is stored in a cache memory and includes data of a plurality of virtual sub-pixels for each of a plurality of pixels, into a main memory, applying predetermined compression processing to the image data; and
when reading out the image data stored in the main memory from the main memory and writing the read image data into the cache memory, applying predetermined decompression processing to the read image data.

2. The image data processing method according to claim 1, wherein the image data is data which includes color data.

3. The image data processing method according to claim 1, further comprising:
separating data of each of the plurality of pixels stored in the cache memory into sequence data in which a data content of each of the sub-pixels is arranged in a first order, and index data which indicates a rank of data used by each of the sub-pixels in the first order,
wherein in the predetermined compression processing, each of the data of the plurality of pixels is converted to a group of per-rank data in which the data of each of the sub-pixels is arranged in a second order for each rank in the first order, and a group of index data in which the index data of each of the plurality of pixels is arranged in the second order.

4. The image data processing method according to claim 3, wherein when the image data stored in the main memory is read out, a group of per-rank data of a first rank in the first order is not read out, and each group of per-rank data of and after a second rank in the first order and the group of index data are read out, to apply the predetermined decompression processing.

5. The image data processing method according to claim 4, wherein flag data which indicates whether or not data of the first rank is unknown is provided for each of the sub-pixels stored in the cache memory.

6. The image data processing method according to claim 5, wherein when the image data stored in the main memory is read out, the flag data is made to be predetermined first data which indicates that the data of the first rank is unknown.

7. The image data processing method according to claim 6, wherein when the data is written with respect to a sub-pixel the flag data of which is the predetermined first data, the flag data is made to be predetermined second data which indicates that the data of the first rank is not unknown.

8. The image data processing method according to claim 1, wherein when the image data stored in the cache memory is written into the main memory, a write mask is used on the group of per-rank data of the first rank in the first order.

9. An image data processor comprising:
a cache memory configured to store image data which includes data of a plurality of virtual sub-pixels for each of a plurality of pixels,
a compression circuit configured to apply predetermined compression processing to the image data when the image data stored in the cache memory is written into a main memory; and
a decompression circuit configured to, when the image data stored in the main memory is read out from the main memory and written into the cache memory, apply predetermined decompression processing to the read image data.

10. The image data processor according to claim 9, wherein the image data is data which includes color data.

11. The image data processor according to claim 9,
wherein data of each of the plurality of pixels stored in the cache memory is separated into sequence data in which a data content of each of the sub-pixels is arranged in a first order, and index data which indicates a rank of data used by each of the sub-pixels in the first order, and
wherein in the predetermined compression processing, the compression circuit converts each of the data of the plurality of pixels to a group of per-rank data in which the data of each of the sub-pixels is arranged in a second order for each rank in the first order, and a group of index data in which the index data of each of the plurality of pixels is arranged in the second order.

12. The image data processor according to claim 11, wherein when the decompression circuit reads out the image data stored in the main memory, the decompression circuit does not read out a group of per-rank data of a first rank in the first order, and reads out each group of per-rank data of and after a second rank in the first order and the group of index data, to apply the predetermined decompression processing.

13. The image data processor according to claim 12, wherein flag data which indicates whether or not data of the first rank is unknown is provided for each of the sub-pixels stored in the cache memory.

14. The image data processor according to claim 13, wherein when the image data stored in the main memory is read out, the flag data is made to be predetermined first data which indicates that the data of the first rank is unknown.

15. The image data processor according to claim 14, wherein when the data is written with respect to a sub-pixel the flag data of which is the predetermined first data, the flag data is made to be predetermined second data which indicates that the data of the first rank is not unknown.

16. The image data processor according to claim 9, wherein when the image data stored in the cache memory is written into the main memory, a write mask is used on the group of per-rank data of the first rank in the first order.

17. A data structure of image data including data of a plurality of virtual sub-pixels for each of a plurality of pixels, the data structure comprising:
when data of each of the plurality of pixels has been separated into sequence data in which a data content of each of the sub-pixels is arranged in a first order, and index data which indicates a rank of data used by each of the sub-pixels in the first order,
a group of per-rank data in which the data of each of the sub-pixels of each of the plurality of pixels is arranged in a second order for each rank in the first order; and
a group of index data in which the index data of each of the plurality of pixels is arranged in the second order.
